(19) United States
(12) Patent Application Publication
(10) Pub. No.: US 2023/0246451 A1
(43) Pub. Date: Aug. 3, 2023

(54) Generating Unit With Integrated Power Electronics to Comply With the Feed-In Requirements of Public Power Grids

(71) Applicant: Orcan Energy AG, Muchen (DE)

(72) Inventors: Alexander Bischoff, Dachau (DE); Fabian Weigand, Munchen (DE)

(21) Appl. No.: 18/004,714

(22) PCT Filed: Jul. 13, 2021
(86) PCT No.: PCT/EP2021/069422

§ 371 Date: Jan. 9, 2023

(30) Foreign Application Priority Data
Jul. 14, 2020 (EP) 20185775.2

(51) Int. Cl. H02J 3/38; H02J 3/18

(52) U.S. Cl. CPC H02J 3/381; H02J 3/18; H02J 2203/20

(57) ABSTRACT

A generating unit, GU, with an asynchronous generator with a direct connecting branch to a power grid; a measuring device for determining the profiles of a GU grid voltage and an GU grid current at the power grid; and power electronics connected in parallel with the asynchronous generator and the power grid. The power electronics including an inverter with an inverter output for direct connection to the generator power grid branch; an intermediate circuit energy storage device; and a control unit. Based on the grid current measured and the grid voltage measured, the control unit can determine a phase shift angle and the value of the grid current and, based on this, actuate the inverter such that the value and phase shift angle of the output current of the power electronics assume values that, together with the current of the asynchronous generator, result in a target phase shift angle.

### TECHNICAL FIELD

The present invention relates to a generating unit, GU, with integrated power electronics to comply with feed-in requirements of public power grids to improve grid stability, as well as to a generating system, GS, with the GU.

### BACKGROUND OF THE INVENTION

If a machine converts non-electrical energy into electrical energy for it to be fed into the public power grid, certain requirements then apply for maintaining grid stability, such as the possibility of remote-controlled active power reduction, active power adjustment in the event of frequency deviations, the provision of reactive power for static voltage stability and faults ride-through, i.e. running through a strong voltage change with the highly dynamic grid support using reactive current. Depending on the national regulations, these requirements are defined in guidelines, rules of application, decrees or the like.

These requirements for a GU are typically implemented entirely or in part by using an externally excited synchronous generator or by using a frequency converter system between the generator and the power grid as implemented in FIG. 1. If the synchronous generator cannot be controlled with regard to the excitation and therefore the reactive power, a frequency converter system must likewise be used between the former and the power grid.

FIG. 1 shows the schematic structure of a GU (100) known from prior art with power electronics (130) connected in series with an electrical AC generator (120) which feeds the active power supplied by the generator into a public power grid (170) and also provides reactive power in all possible quadrants.

The current generated by the generator is first rectified using a rectifier/generator converter (131) and routed via the intermediate circuit capacitor (132), and then converted back by way of an inverter/grid converter (133) using modulation (e.g. pulse width modulation, PWM) into an approximately sinusoidal alternating current having a frequency equal to the grid voltage. Depending on the required reactive power, the current is there fed into the grid sooner or later in relation to the grid voltage. Theoretically, converter systems without an intermediate circuit or mixed forms are also conceivable.

The active power fed into the power grid (170) can also be controlled by energizing a brake resistance (140), the chopper: the brake resistance (140) is switched via an electronic switch (134), the so-called chopper, to be clocking parallel to the Intermediate circuit capacitor (132) so that excess energy in the intermediate circuit capacitor (132) is converted into thermal energy. As a rule, the chopper is activated automatically when a specific intermediate circuit voltage is exceeded, which is the result of the power limitation of the grid converter (133) and as a result of which more current is introduced into the intermediate circuit than can also be drawn.

As an alternative or in addition, the ultimately required power fed into the grid can be set by controlling the process input power (111) of a primary energy source which is converted using a primary energy converter (112) into mechanical power for driving the generator (120).

This configuration has the drawback that the entire active power provided by the generator (120) has to be routed through the lossy power electronics (130). Furthermore, the serial connection of the power electronics (130) requires two converters, a rectifier (131) and an inverter (133).

The invention is based on the object of providing a GU which overcomes the drawbacks mentioned.

This object is satisfied by the object of claim 1.

Advantageous embodiments are the object of the dependent claims.

### SUMMARY

A summary is provided below to present a representative selection of concepts in a simplified manner that shall be further discussed in the subsequent detailed description.

According to preferred configurations, a GU can be composed of an asynchronous generator with a direct connecting branch to a power grid, a measuring device for determining the profiles of a GU grid voltage and a GU grid current at the power grid, as well as power electronics.

The power electronics can there be connected in parallel with the asynchronous generator and the power grid in order to feed a current into the power grid that is shifted with respect to the grid voltage. The power electronics can preferably be connected at a node within the GU in parallel with the asynchronous generator and the power grid. The voltage present at the node can correspond to a low voltage in the range of approximately 0.4 kV.

The power electronics can comprise an inverter with an inverter output for direct connection to the generator power grid branch and an intermediate circuit energy storage device having an intermediate circuit voltage that is connected in parallel with the inverter on the DC side. The power electronics can also comprise a control unit. The intermediate circuit energy storage device there preferably corresponds to an intermediate circuit capacitor and the inverter to a two-level, three-level or multi-level inverter. The inverter can also comprise an output filter for smoothing the pulsing inverter output current, which can be connected in series between the output terminals of the inverter and the node.

Based on a GU grid current measured and a grid voltage measured, the control unit can determine a phase shift angle and the value of the GU grid current and, based on this, actuate or control the inverter such that the value and the phase shift angle of the output current of the power electronics assume values which, together with the current of the asynchronous generator, result in a target value and a target phase shift angle of the GU grid current. The inverter is preferably there actuated with a pulse width modulated signal. The actuation of the inverter can preferably have a tolerance band control or a vector control in a d/q coordinate system revolving at the grid frequency. In addition, the control unit can determine a value of the active grid current based on the grid current measured and the grid voltage measured.

The inverter can also be actuated by the control unit based on the intermediate circuit voltage of the intermediate circuit energy storage device such that the intermediate circuit energy is converted by pulse width modulation (PWM) into an approximately sinusoidal, three-phase alternating current with a frequency approximately the same as that of the grid, a variable amplitude, and a variable phase shift between the grid voltage and the inverter output current.

Furthermore, the GU can comprise a chopper with a serial brake resistance for controlling the active power fed into the grid. The series composed of the chopper and the brake resistance can be connected in parallel with the DC side of the inverter. The chopper can be actuated by a voltage comparison with a hysteresis such that the energy stored in the intermediate circuit energy storage device can be converted into thermal energy by switching on the brake resistance. The actuation of the chopper can also comprise tolerance band control. If the inverter is actuated such that a current flows from the node in the direction of the intermediate circuit and its voltage rises as a result, then the chopper can dissipate the excess energy to the brake resistance and enable the active power fed into the grid to be controlled.

In addition, the GU can comprise an Organic Rankine Cycle, ORC, unit/system with an expansion machine which can drive the asynchronous generator. The asynchronous generator can be integrated into the expansion machine, where the asynchronous generator preferably corresponds to an AC asynchronous machine with a short-circuit/squirrel cage rotor.

Furthermore, the GU mentioned can be connected in parallel with a plurality of other GUs on the low-voltage side of a transformer within an GS. The high-voltage side of the transformer can preferably be connected to a grid connection point of a medium-voltage grid.

### FIGURES

Preferred embodiments of the invention shall be explained in more detail below with reference to the drawings, where:

FIG. 1 shows a schematic structure of a GU with power electronics connected in series according to prior art;

FIG. 2A shows a schematic structure of a GU with power electronics connected in parallel according to an embodiment of the invention;

FIG. 2B shows a simplified equivalent circuit diagram of the power electronics according to the embodiment of FIG. 2A;

FIG. 3 shows a schematic structure of a GU with a feed into a medium-voltage grid, comprising a plurality of GUs;

FIG. 4A shows an equivalent circuit diagram of a grid with a grid-feed-in GU according to the embodiment of FIG. 2A;

FIG. 4B shows a vector diagram for the equivalent circuit diagram according to FIG. 4A;

FIG. 4C shows a further vector diagram for the equivalent circuit diagram according to FIG. 4A;

FIG. 4D shows a schematic profile of the normalized voltage increase at the grid connection point of the GU b way of the shift factor cos φ according to the embodiment of FIG. 2A; and

FIG. 5 shows a schematic control circuit for the power electronics of the embodiment according to FIG. 2A for realizing the phase shift angle φ.

### DESCRIPTION

Unless otherwise stated, complex numbers are used hereafter in the notation

X=Re{X}+jIm{X}=Xᵣ+jX_{q}=Xe^{jφ}=X[sin(φ)+j cos(φ)].

Furthermore, unless otherwise stated, the term ‘phase shift angle φ’ is used hereafter for the phase shift between the voltage and the corresponding current. Furthermore, unless otherwise stated, the term ‘phase shift angle φ’ is used hereafter for the phase shift between the voltage and the corresponding current. Furthermore, unless otherwise stated, the term ‘phase shift angle φ’ is used hereafter for the phase shift between the voltage and the corresponding current.

Furthermore, unless otherwise stated, the term ‘value’ is used for the effective value of an AC magnitude.

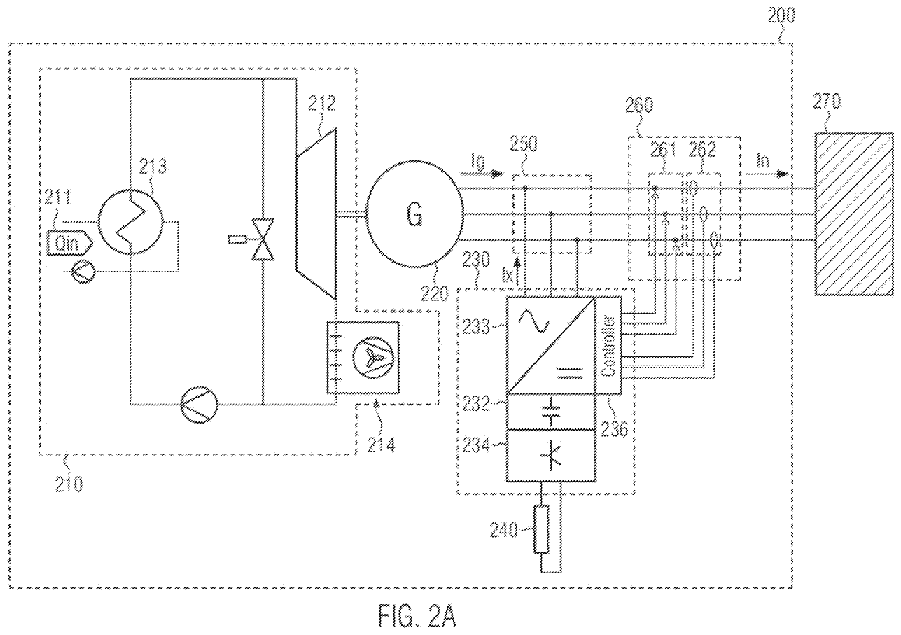

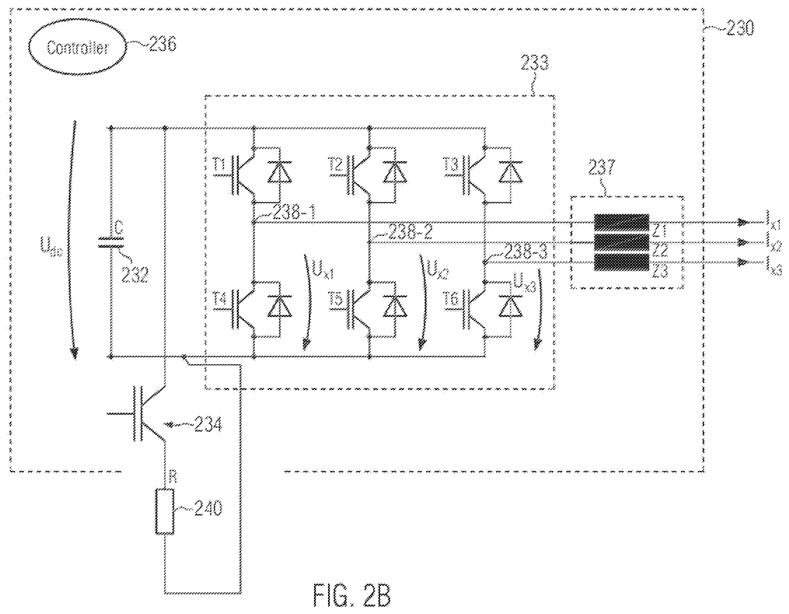

FIG. 2A shows the schematic structure of a generating unit, GU, (200) according to an embodiment of the invention in which the power electronics (230) are connected in parallel with the generator (220) and the public power grid (270).

The generator (220) can there be connected directly to the power grid (270) without the power electronics (130) known from prior art connected in series between the generator and the power grid, and can feed the active electrical power generated by the generator (220) into the power grid (270) directly and with almost no losses.

As shown in FIG. 2A, the output of the power electronics (230) can be connected in parallel with the generator and the power grid (270) via a feed-in point or node (250). Reactive and active power can be exchanged between the node (250) and the power electronics (230) by feeding in or feeding back a current that can be adjusted according to the phase angle and the amplitude. Accordingly, all feed-in requirements of the GU (200) can be implemented by the power electronics (230) connected in parallel, without having to route the electrical generator power through the lossy power electronics.

According to one aspect, the GU (200) can comprise a measuring device (260) with a voltage measuring device (261) for measuring the grid voltage profile and a current measuring device (262) for measuring the grid current profile. The voltage (261) and current measuring devices (262) can there preferably each comprise three measuring sensors for phase-by-phase measurement of the voltage or current strength, respectively, in the power grid. As an alternative, the measurement can be conducted with two sensors (Aaron circuit). In addition, the measuring device (260) can comprise a power meter for direct power measurement.

Furthermore, the GU (200) can comprise an Organic Rankine Cycle, ORC, unit/system (210) shown schematically in FIG. 2A with which heat output (211) can be converted into electrical power. The heat output (211) supplied can be transferred using a vaporizer (213) to a work medium which preferably consists of an organic liquid. The enthalpy of the work medium mass flow can be used by way of an expansion machine (212) in mechanical power to drive the generator (220) and ultimately be converted into electrical power for being fed direct into the public power grid (270). In addition, the ORC system can comprise a condenser for liquefying the expanded work medium (214).

According to one aspect, the generator (220) can comprise an asynchronous generator which preferably corresponds to a AC asynchronous machine with a short-circuit or squirrel-cage rotor. In one aspect, the asynchronous generator can be integrated into the expansion machine (212).

As shown in FIG. 2A, the power electronics (230) can comprise an inverter (233), an intermediate circuit energy storage device (232), a chopper (234), a brake resistance (240) and a control unit (236). These components can be interconnected in detail in accordance with the circuit diagram in FIG. 2B.

As shown in FIG. 2B, the intermediate circuit energy storage device (232) can be connected in parallel with the inverter (233), where the intermediate circuit energy storage device (232) preferably corresponds to a capacitor. As an alternative, the energy storage device can also comprise a superconducting energy storage device, a fuel cell, and/or a chargeable battery.

The inverter can preferably comprise three half-bridges, each with two switching elements which can switch the intermediate circuit voltage U_{dc} present at the intermediate circuit energy storage device (232) with positive or negative polarity to the respective bridge branch or respective inverter phase output (238-1, 238-2, 238-3). Switching elements T1 . . . T6 of the inverter (233) can be actuated with a PWM actuation signal generated by the control unit (236), so that three approximately sinusoidal AC voltages Uₓ₁ . . . Uₓ₃ offset by 120° can be generated. An inverter (233) of this type can be configured, for example, as a two-level inverter, three-level inverter, or multi-level inverter. The switching elements used in the half-bridge preferably comprise IGBTs with anti-parallel freewheeling diodes, where the freewheeling diodes can enable energy to flow from the power grid (270) into the inverter (233).

The control unit (236) preferably comprises an inlet for being able to receive the grid voltages and grid currents measured by the measuring device (260). The measurement results determined by the measuring device (260) can there be transmitted to the control unit (236) preferably via a hardwired electrical signal line or alternatively via a network interface or a wireless network interface, such as wireless LAN or Bluetooth.

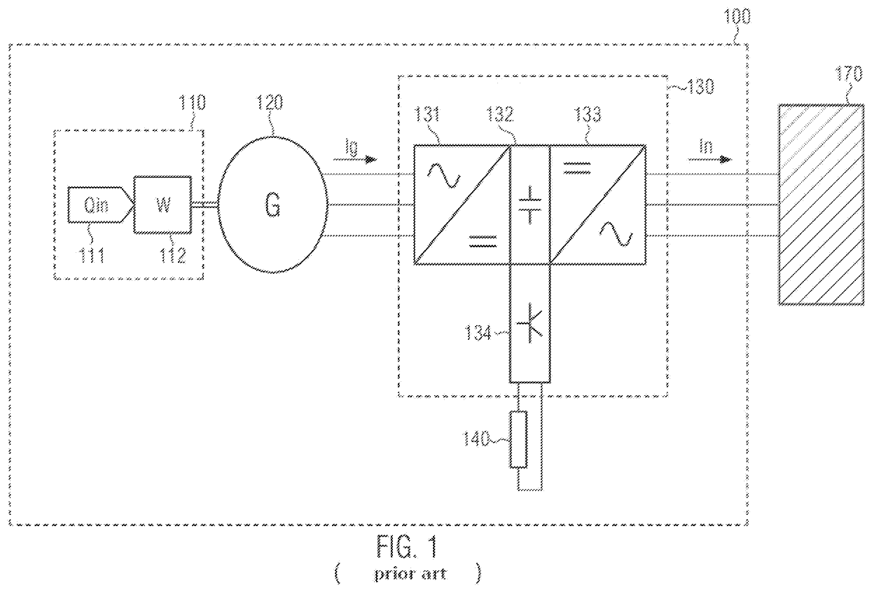

According to a further aspect, the chopper (234), as shown in FIG. 2B, can be connected in series with the brake resistance (240). Furthermore, the serial connection of the chopper (234) and the brake resistance (240) can be connected in parallel with the inverter (233) and the intermediate circuit energy storage device (232). In contrast to the serial connection of the power electronics (130) according to FIG. 1, in which the intermediate circuit voltage increases due to the limitation by the inverter (133) of the active grid power fed in, the inverter (233) in the parallel connection can receive active power in the amount of an adjusted active power reduction in the intermediate circuit energy storage device (232). Furthermore, the brake resistance can be switched into the current path by cyclically switching the chopper (234) so that the energy stored in the intermediate circuit energy storage device (232) can be converted into thermal energy by way of the brake resistance (240). The chopper (234) preferably consists of an electronic switch such as an insulated gate bipolar transistor, IGBT, a metal-oxide-semiconductor field effect transistor, MOSFET, or a transistor.

According to one aspect, the power electronics (230) can comprise a serial output filter or output chokes (237) for smoothing the pulsing inverter output current. The output filter (237) can there be integrated into the inverter (233) or connected in series with the inverter output. The output filter (237) preferably comprises at least three output chokes which can be connected in series with the respective inverter phase output (238-1, 238-2, 238-3). In addition or as an alternative, the output filter (237) can comprise a three-phase transformer for grid connection. Unless otherwise specified, only the inductive part of phase impedances Z1 . . . Z3 of the output filter is examined for the sake of simplicity. Those skilled in the art understand that phase impedances Z1 . . . Z3 can also be composed of a transformer impedance and/or grid connection impedance.

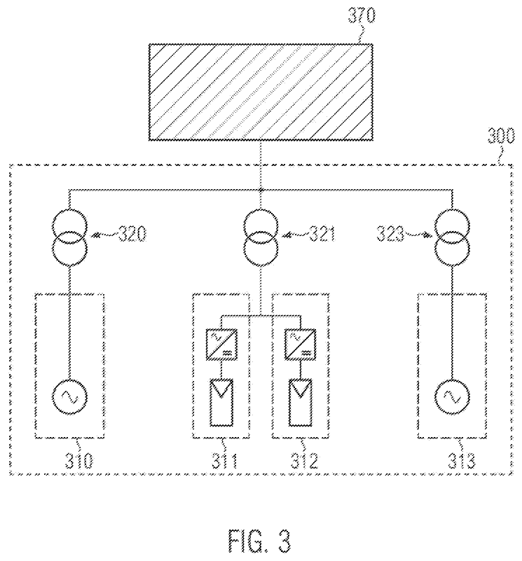

FIG. 3 shows a schematic structure of a generating system (300), GS, comprising a plurality of GUs (310 . . . 313), where one or more of the GUs, for example GU (310), can correspond to the GU shown in FIG. 2A (200) or the GU (100) according to FIG. 1. As shown in FIG. 3, the electrical energy provided by the GUs (310 . . . 313) can be fed into the public power grid (370) via transformers (320, 321, 323) at a grid connection point, where the power grid preferably comprises a medium-voltage grid with a 20-kV grid connection point. Furthermore, FIG. 3 shows that the GUs (310-313) can each be connected to the low-voltage side, corresponding to a low-voltage level, of a transformer (320, 321, 323). According to one aspect, several GUs (311, 312) can also be connected in parallel with the low-voltage side of a transformer (321). According to one aspect, the GUs (310 . . . 313) can be, for example, wind power, photovoltaic or ORC GUs.

### Operating Principle of the Power Electronics

The schematic structure of the GU (200), the GS (300), and the power electronics (233) has presently been described. The operating principle and the setting options for phase shift angle go with the power electronics (233) according to the embodiment of FIG. 2A or FIG. 2B, respectively, shall be discussed hereafter. The equations presented below are based on the simplified assumption that the ohmic part of output, grid and/or transformer impedances Z1 . . . Z3 is negligibly small and the three-phase grid voltage of the power grid (270) corresponds approximately to the three-phase output voltage of the generator (220).

Based on the intermediate circuit voltage U_{DC} defined by the topology of the inverter (233) and the grid voltage, the inverter (233) can generate an approximately sinusoidal and symmetrical AC system at the output of the filter (237). Depending on the type of inverter (line-commutated or self-commutated), an external grid may be necessary for this. This AC system can be connected in parallel with the grid (270) and the generator (220).

The generated m^{th} inverter phase output current iₓₘ(t) with 1≤m≤3 can have a time profile according to

iₓₘ(t)=\sqrt{2}iₓₘ sin(ωt−φ)

where ω can correspond to the angular frequency of the voltage of the grid (270), Iₓₘ to the magnitude or effective value of the m^{th} inverter phase output current and go to the phase shift angle, i.e. the phase shift between iₓₘ and the m^{th} inverter phase output voltage uₓₘ.

### Provision of Reactive Power

Based on the magnitude and the phase shift angle go of the respective inverter phase output current generated, reactive power can be exchanged between the power electronics (230) and the node (250), similar to a conventional phase shifter. For this purpose, the inverter phase output current is fed in or drawn offset to the grid voltage.

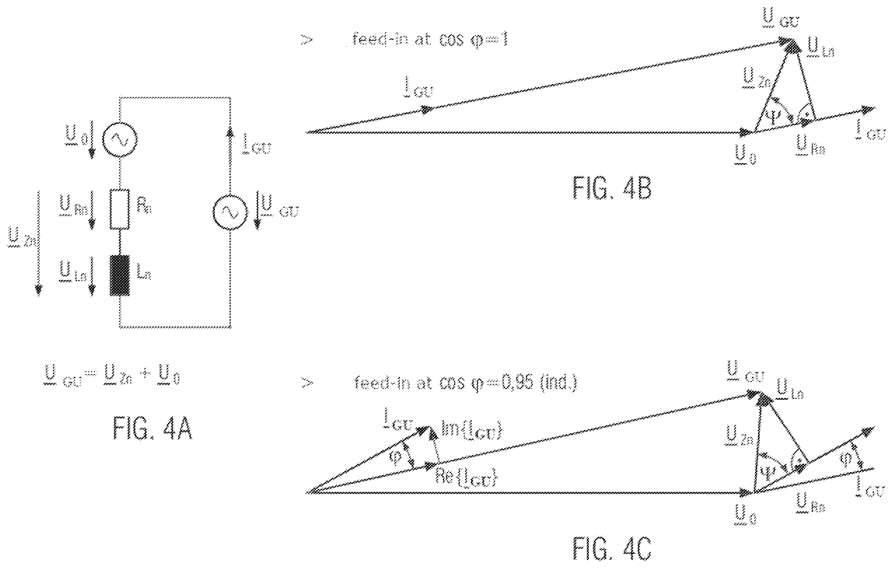

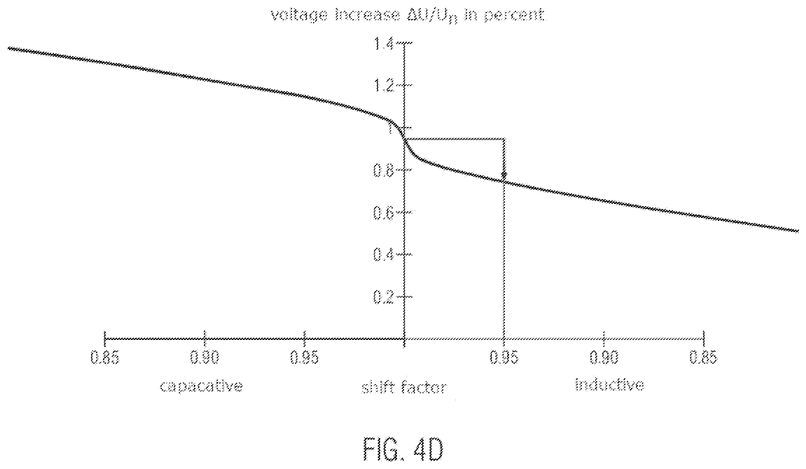

FIG. 4A shows an equivalent electrical circuit diagram of a grid with a grid-feed-in GU according to the embodiment of FIG. 2A. As shown in FIG. 4A, the electrical grid comprises a grid voltage source having the source voltage U₀, a grid impedance having a resistance Rₙ (active resistance), and an inductance Rₙ (reactive resistance), as well as power electronics according to the embodiment of FIG. 2B. By setting the inverter output current Iₓ, a total grid current I_{GU} can be provided which causes a voltage drop across the grid impedance according to U_{Z}n=U_{Rn}+U_{Ln}.

As shown in the corresponding vector diagram in FIG. 4B, pure active power (φ=0; I_{GU}=Re{I_{GU}}) can then be fed into the power grid. FIG. 4C shows an alternative state in which a reactive current Im{I_{GU}} is fed in in addition to the active current Re{I_{GU}} fed in in FIG. 4B. The shift factor cos φ is 0.95 (inductive).

FIG. 4D shows a schematic profile of the normalized voltage increase at the grid connection point of the GU over the shift factor cos φ. The voltage increase at a grid impedance angle of ψ=30° (typical for the low-voltage grid) is there shown. Accordingly, the voltage at the grid connection point can be set for ‘static voltage stability’ of the GU by phase shifting the feed-in current. For example, as shown in FIG. 4D, with a shift factor of 0.95 (inductive), the voltage rise can be reduced by about 20%. According to one aspect, the voltage at the grid connection of the GU can be set such that the permissible grid voltage limits are observed. In principle, but according to a different control mode, grid support also works in the event of a severe voltage drop, the low voltage ride through, LVRT.

Active Power Control Through Active Power Drawn by the Power Electronics

In addition or as an alternative, active power can be transferred from the node (250) to the intermediate circuit energy storage device by appropriate PWM of the power electronics (230). As a result, the intermediate circuit voltage can rise and the automatically triggered chopper (234) can dissipate the excess energy to the brake resistance (240). In this way, the active power of the GU fed in can thus be controlled.

According to one aspect, as shown in Table 1, different phase shift angles can lead to different quadrants of performance. The resulting current from the power electronics and the effect on the grid feed-in are considered there. The initial situation of an ORC process in operation is examined there, in which active power is fed into the grid and inductive reactive power is drawn. The signage corresponds to the consumer sign convention.

TABLE 1
Setting options for the PWM and their consequences

| Quadrant of | | | |
|---|---|---|---|
| the power | | | |
| electronics | Effect on | Effect on | |
| of the | GU grid | GU grid | Chopper |
| complex level | active power | reactive power | status |
| 1 | decreases | inductive | ACTIVE |
| | | reactive power | |
| | | draw increases | |
| 2 | None, quadrant | None, quadrant | N/A |
| | not possible | not possible | |
| 3 | None, quadrant | None, quadrant | N/A |
| | not possible | not possible | |
| 4 | decreases | inductive | ACTIVE |
| | | reactive power | |
| | | draw decreases | |

### Active and Reactive Power Control

Actuating the inverter (233) and the chopper (234) with the control unit (236) for reactive and active power control with the power electronics (230) shall be discussed hereafter according to the embodiment of FIG. 2A.

According to one aspect, the value of the current in the power electronics Iₓ and the phase shift angle φₓₙ between the current of the power electronics and the grid voltage can be set such that adding the generator current I_{g} results in a grid current Iₙ which at an agreed point exceeds the required target active power and can provide the required target reactive power. Accordingly, the power electronics currents Iₓ impressed or exchanged at the node (250) can exhibit a value Iₓ and a phase shift angle φₓₙ in relation to the grid voltage according to

Iₓ∠φₓₙ=Iₓ=Iₙ−I_{g}=I_{n,r}+jI_{n,g}−(I_{g,r}+jI_{g,q}).

As can be seen by a person skilled in the art, the magnitude of reactive current in the power electronics can decrease when the reactive current of the generator I_{g,q} and the required grid reactive current I_{n,q} cancel each other out in part or entirely. This could be the case when the generator draws inductive reactive power (in consumer sign convention, VZS, Q_{g}>0) and grid-related inductive reactive power is required by the GU. When capacitive reactive power is drawn on the grid side, the values of reactive current of the generator (220) and of the power grid (270) can add up, which means that the value of reactive current of the power electronics (230) can increase.

According to one aspect, the regulation of the active power can be set remotely or in dependence of the frequency. The active power can be converted by adjusting the process entry power (the heat output (211) supplied to the ORC system (210)). In addition or as an alternative, the excess energy from the node (250) can be converted into thermal energy via the intermediate circuit energy storage device (232), the chopper (234) and the brake resistance (240) and thus dissipated from the GU (200).

According to one aspect, the provision of reactive power for static voltage stability and/or for dynamic grid support, fault ride-through, FRT, can be controlled by shifting the output current of the power electronics. In this case, controlling the static voltage stability and/or dynamic grid support can be optimized, where the control error in the static voltage stability is corrected with a greater control settling time than in the case of dynamic grid support.

According to one aspect, methods known to those skilled in the art such as tolerance band control or phased feedback of the grid current with the target value of the grid current via a P controller can be used to control the power electronics output current and/or the grid current. According to one aspect, the control can comprise vector control in a coordinate system (d/q coordinates) revolving at grid frequency.

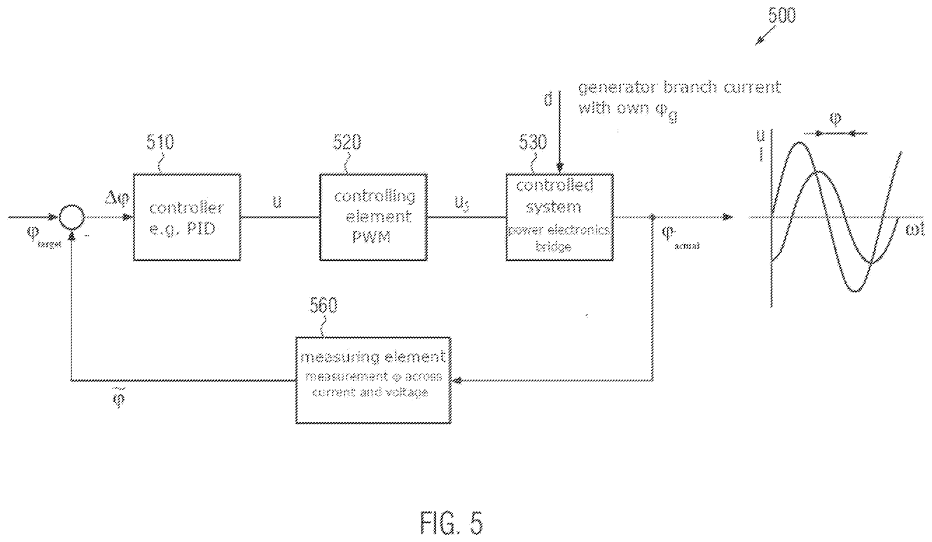

FIG. 5 shows a schematic control circuit (500) for the power electronics of the embodiment according to FIG. 2A for realizing the phase shift angle go in phase shifter operation, shown in representation for one phase of the three-phase system. An actual phase shift angle \tilde{φ} can there be determined based on the temporal phase shift between the grid voltage supplied by the measuring device (560) and the grid current of the phase to be controlled. Based on the control deviation Δφ between the target phase shift angle φ_{target} and the determined phase shift angle \tilde{φ}, the ignition times u for the switching elements of the respective bridge branch of the inverter are set with a controller (510), where the controller (510) preferably comprises a P, PI, or PID controller. PWM actuation signals us for the switching elements of the bridge branch, the controlled system (530), can be formed from the ignition times u using a PWM controller or converter (520). The phase shift angle φ_{g} between the phase grid voltage and the generator branch current can influence the controlled system (530) as a disturbance variable d.

Omitting the rectifier (131) in the embodiment according to FIG. 2A reduces the space requirement and the heat loss in the switch cabinet system. In addition, the degree of efficiency of the GU (200) can be increased by around 4 . . . 7% by feeding the generated generator power directly into the power grid (270). Furthermore, the costs for the power electronics can be reduced by around 38%.

Another advantage can be the reduced winding stress for the generator (220): While the generators in the serial connection of the power electronics (130) need to be configured for chopped DC voltages of 600 . . . 800 V with high slew rates, the generator (220) can be configured according to FIG. 2A for sinusoidal grid AC voltage having a frequency of 50 . . . 60 Hz. The effect of the “damaging bearing currents” caused by the serial power electronics (130) can also be prevented with the parallel connection according to FIG. 2A.

A further advantage can be that the GUs (200, 310 . . . 313) are built modularly and uniformly in the sense of a kit and, depending on the required feed-in requirements, can be optionally equipped or retrofitted with or without power electronics (230) for a certified feed-in.

1. A generating unit, GU, comprising:
an asynchronous generator with a direct connecting branch to a power grid;
a measuring device for determining the profiles of a GU grid voltage and a GU grid current at the power grid;
power electronics that are connected in parallel with said asynchronous generator and said power grid, said power electronics comprising:
an inverter with an inverter output for direct connection to said generator power grid branch;
an intermediate circuit energy storage device that is connected in parallel with said inverter on the DC side, where said intermediate circuit energy storage device comprises an intermediate circuit voltage;
a control unit which, based on the grid current measured and the grid voltage measured, determines a phase shift angle and the value of the grid current and, based on this, actuates said inverter such that the value and phase shift angle of the output current of said power electronics assume values that, together with the current of said asynchronous generator, result in a target phase shift angle.

2. The generating unit according to claim 1, further comprising a chopper with a serial brake resistance for controlling the active power fed into the grid, where the series composed of said chopper and said brake resistance is connected in parallel with the DC side of said inverter.

3. The generating unit according to claim 1, wherein said generating unit comprises an Organic Rankine Cycle, ORC, unit with an expansion machine, where said asynchronous generator is driven by said expansion machine.

4. The generating unit according to claim 3, wherein said asynchronous generator is integrated into said expansion machine.

5. The generating unit according to claim 1, wherein said asynchronous generator corresponds to an AC asynchronous machine with a short circuit/squirrel-cage rotor.

6. The generating unit according to claim 1, wherein said inverter corresponds to a two-level, three-level or multi-level inverter.

7. The generating unit according to claim 1, wherein said intermediate circuit energy storage device comprises at least one intermediate circuit capacitor.

8. The generating unit according to claim 1, wherein said control unit calculates a PWM based on the grid voltage measured and the grid current measured such that the value and the phase shift angle of the output current of said power electronics assume the values that, together with the current of said asynchronous generator, result in the target value of the grid current and the target phase shift angle.

9. The generating unit according to claim 2, wherein said chopper is actuated such that the energy stored in said intermediate circuit energy storage device is converted into thermal energy by way of said brake resistance.

10. The generating unit according to claim 1, wherein said inverter output comprises a serial output filter for smoothing the pulsing inverter output current.

11. The generating unit according to claim 1, wherein the actuation of said inverter comprises a control, where the control comprises a tolerance band control or a vector control in a d/q coordinate system revolving at the grid frequency.

12. The generating unit according to claim 1, wherein the GU provides a reactive power of up to about 200 kvar.

13. A generating system comprising:
a transformer with a low and high voltage side for direct connection to a grid connection point of the medium-voltage grid;
one or a plurality of generating units connected in parallel with the low-voltage side of said transformer, where at least one generating unit corresponds to said generating unit of claim 1.
